(19) United States
(12) Patent Application Publication
(10) Pub. No.: US 2014/0016322 A1
(43) Pub. Date: Jan. 16, 2014

(54) LIGHT EMITTING DEVICE

(71) Applicant: Lextar Electronics Corporation, Hsinchu (TW)

(72) Inventor: Yu-Shin Lu, Changhua County (TW)

(73) Assignee: Lextar Electronics Corporation, Hsinchu (TW)

(21) Appl. No.: 13/903,039

(22) Filed: May 28, 2013

(30) Foreign Application Priority Data
Jul. 12, 2012 (TW) 101125176

(51) Int. Cl. F21V 14/04

(52) U.S. Cl. CPC F21V 14/04
USPC 362/282

(57) ABSTRACT

A light emitting device comprising a reflection cap, a substrate, a light source, a first wavelength transformation layer, a second wavelength transformation layer, a cover and a reflection device is provided. The substrate is disposed on the reflection cap. The light source is disposed on the substrate. The first wavelength transformation layer disposed on the substrate surrounds the light source. The second wavelength transformation layer disposed on the substrate surrounds the first wavelength transformation layer. The cover is fixed on the reflection cap. The reflection device comprises a reflection angle adjustment mechanism and a reflector. A ratio of the light reflected by the reflector to be incident on the first wavelength transformation layer to that being incident on the second wavelength transformation layer is adjusted through the angle adjustment of the reflector by the reflection angle adjustment mechanism to generate light with different color temperature.

This application claims the benefit of Taiwan application Serial No. 101125176, filed Jul. 12, 2012, the subject matter of which is incorporated herein by reference.

### BACKGROUND OF THE INVENTION

1. Field of the Invention

The invention relates in general to a light emitting device, and more particularly to a light emitting device with adjustable color temperature.

2. Description of the Related Art

The color temperature of a light output is fixed in a conventional light emitting device. When different color temperature of a light output is desired, the current light emitting device needs to be replaced with a light emitting device conformed to the expected color temperature, hence requiring new design of the light emitting device or incurring derivative procurement cost.

### SUMMARY OF THE INVENTION

The invention is directed to a light emitting device capable of adjusting the color temperature of a light output.

According to one embodiment of the present invention, a light emitting device with adjustable color temperature is provided. The light emitting device comprises a reflection cap, a substrate, a light source, a first wavelength transformation layer, a second wavelength transformation layer, a cover and an angle adjustable reflection device. The reflection cap has a recess. The substrate is disposed on a bottom of the recess. The light source is disposed on the substrate for emitting a light. The first wavelength transformation layer is disposed on the substrate and surrounds the light source. The second wavelength transformation layer is disposed on the substrate and surrounds the first wavelength transformation layer. The cover is disposed over the light source and fixed on the reflection cap. The reflection device facing the light source is disposed on the cover and comprises a reflection angle adjustment mechanism and a reflector. The reflection angle adjustment mechanism is movably disposed on the cover, and the reflector is disposed on the reflection angle adjustment mechanism. A ratio of the light reflected by the reflector to be incident on the first wavelength transformation layer to that being incident on the second wavelength transformation layer is adjusted through the reflection angle adjustment mechanism driving the reflector to change its angle.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a cross-sectional view of a light emitting device according to an embodiment of the invention;

FIG. 2 shows a cross-sectional view of a reflection device of FIG. 1 in a contraction mode;

FIG. 3 shows a cross-sectional view of a reflection device of FIG. 1 in an expansion mode;

FIG. 4 shows an enlargement of a part 4′ of FIG. 1;

FIG. 5 shows a decomposition diagram of the reflection angle adjustment mechanism of FIG. 1; and

FIG. 6 shows a cross-sectional view along a direction 6-6′ of FIG. 4.

### DETAILED DESCRIPTION OF THE INVENTION

Referring to FIG. 1, a cross-sectional view of a light emitting device according to an embodiment of the invention is shown. The light emitting device 100 comprises a reflection cap 110, a substrate 120, a first wavelength transformation layer 130, a second wavelength transformation layer 140, a cover 145, a light source 150 and an angle adjustable reflection device 160.

The reflection cap 110 has a recess 111, wherein the substrate 120, the light source 150, the first wavelength transformation layer 130, the second wavelength transformation layer 140 and the reflection device 160 are disposed inside the recess 111.

The substrate 120 is disposed on a bottom of the recess 111. The substrate 120, such as a dissipation substrate, is electrically connected to an external power for powering the light source 150 to emit a light.

The first wavelength transformation layer 130 is disposed on the substrate 120 and surrounds the light source 140. The first wavelength transformation layer 130, realized by such as a red phosphor layer, makes the reflected second light L21 looked red. Viewing from a top view direction of FIG. 1, the first wavelength transformation layer 130 is a closed or an open ring-shaped wavelength transformation layer.

The second wavelength transformation layer 140 is disposed on the substrate 120 and surrounds the first wavelength transformation layer 130. The second wavelength transformation layer 140, realized b such as a green phosphor layer, makes the reflected second light L22 looked green. Viewing from a top view direction of FIG. 1, the second wavelength transformation layer 140 is a closed or an open ring-shaped wavelength transformation layer.

The cover 145, fixed on the reflection cap 110, covers an opening of the recess 111 and is disposed over the first wavelength transformation layer 130, the second wavelength transformation layer 140 and the light source 150.

The light source 150 is disposed on the substrate 120. The light source 150 is formed by LED such as a blue LED chip. The light emitting device 100 further comprises a transparent encapsulating layer 155 encapsulating the light source 150, wherein the light emitted by the light source 150, after passing through the transparent encapsulating layer 155, is outputted in an original color, that is, as a blue light.

The light source 150 is disposed on the substrate 120 for emitting a first light L1, wherein partial of the first light L11 is reflected to the first wavelength transformation layer 130 and converted to a second light L21, while another partial of the first light L12 is reflected to the second wavelength transformation layer 140 and converted to a second light L22, the second lights L21 and L22 are mixed to form a light with expected color temperature. Respective optical paths when the reflection device 160 contracts and expands are disclosed below.

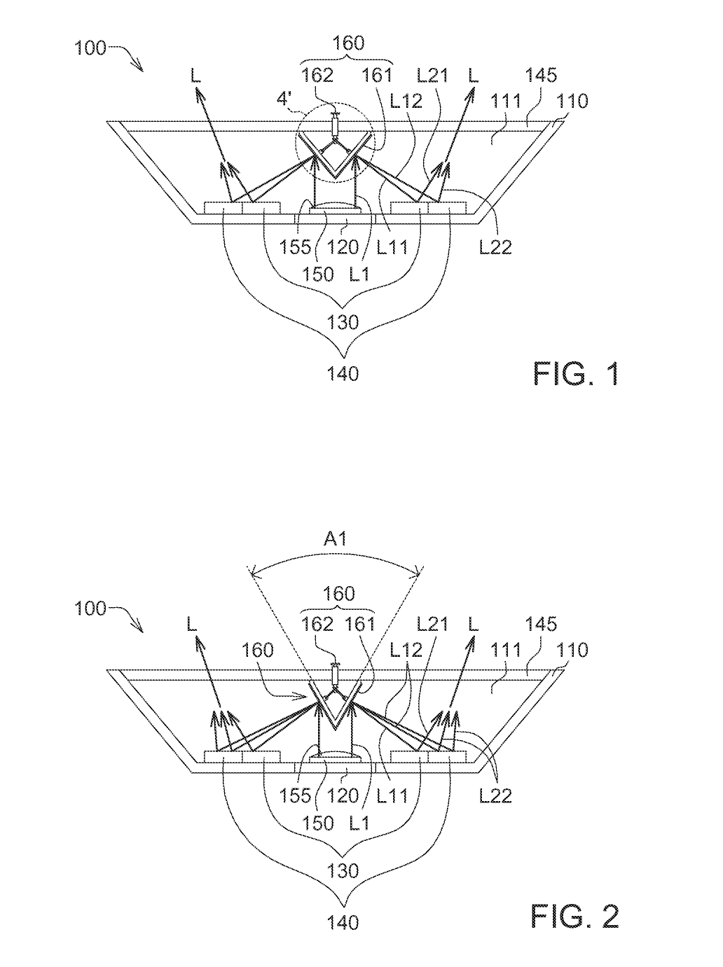

Referring to FIG. 2, a cross-sectional view of a reflection device of FIG. 1 in a contraction mode is shown. When the reflection device 160 contracts, the angle A1 is reduced, so that less first light L11 is reflected to the first wavelength transformation layer 130 and converted to the second light L21 and more first light L12 is reflected to the second wavelength transformation layer 140 and converted to the second light L22. The second light L21 and the second light L22 are mixed to form a light L with expected color temperature, such as a cold white light.

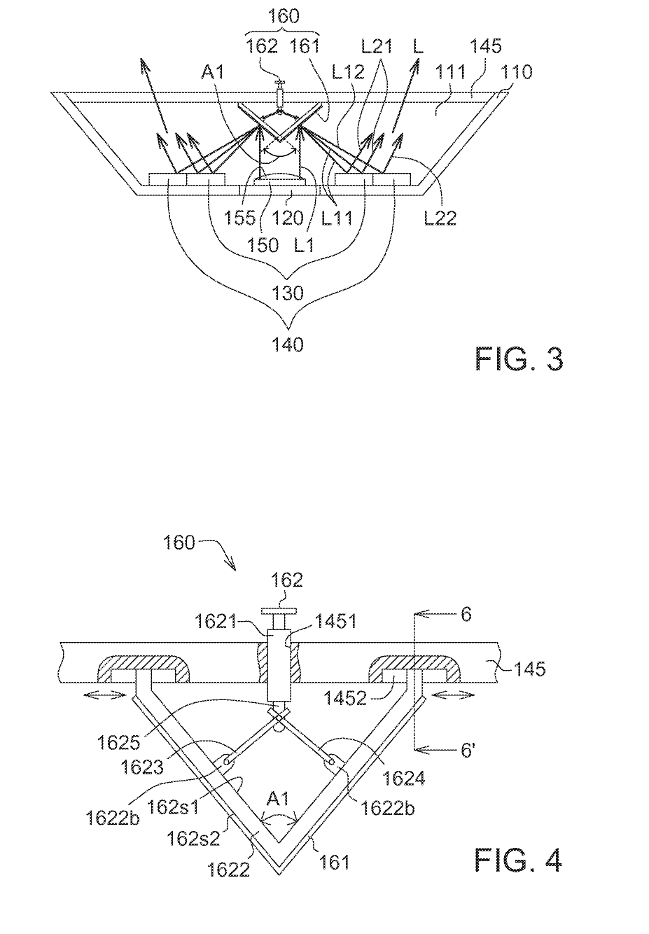

Referring to FIG. 3, a cross-sectional view of a reflection device of FIG. 1 in an expansion mode is shown. When the reflection device 160 expands, the angle A1 is increased, so that more first light L11 is reflected to the first wavelength transformation layer 130 and converted to the second light L21 and less first light L12 is reflected to the second wavelength transformation layer 140 and converted to the second light L22. The second light L21 and the second light L22 are mixed to form a light L with expected color temperature, such as a warm white light. Detailed structure of the reflection device 160 is disclosed below.

Referring to FIG. 4, an enlargement of a part 4′ of FIG. 1 is shown.

The reflection device 160 is disposed on the cover 145, and comprises a reflector 161 and a reflection angle adjustment mechanism 162.

The quantity of the reflector 161 may be singular or plural. The reflector 161 disposed on the reflection angle adjustment mechanism 162 is driven by the reflection angle adjustment mechanism 162 to change its angle for adjusting a ratio of the light emitted by the light source 150 and reflected by the reflector 161 to be incident on the first wavelength transformation layer 130 (FIG. 1) to that incident on the second wavelength transformation layer 140 (FIG. 2) so as to generate light with different color temperature.

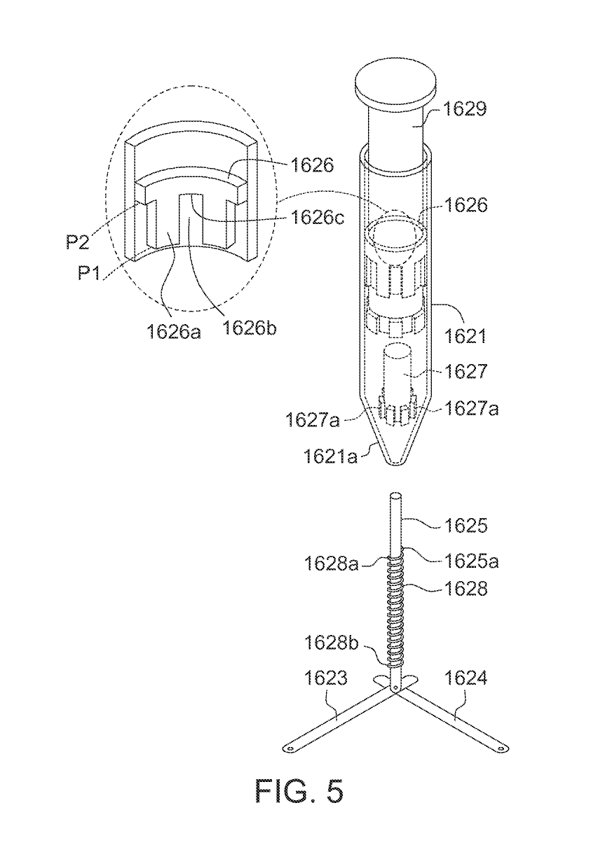

The reflection angle adjustment mechanism 162 is movably disposed on the cover 145, and comprises a sleeve 1621, a V-shaped flexible element 1622, a first rod 1623, a second rod 1624, a core rod 1625 (FIG. 5), a stopper 1626 (FIG. 5), a pushing member 1627 (FIG. 5), an elastic member 1628 (FIG. 5) and an operating rod 1629 (FIG. 5).

The sleeve 1621 is tightly fixed in the through hole 1451 on the cover 145. In another example, the sleeve 1621 and the cover 145 may be formed in one piece.

The V-shaped flexible element 1622 has an inner surface 162s1 and an outer surface 162s2. The outer surface 162s2 faces the light source 150 (illustrated in FIG. 1). The reflector 161 is pasted on the outer surface 162s2. The V-shaped flexible element 1622 comprises two pivotal portions 1622b disposed on the inner surface 162s1 and pivotally connected to the first rod 1623 and the second rod 1624 respectively.

The first rod 1623 and the second rod 1624 intersect each other and respectively are pivotally connected to the core rod 1625.

The core rod 1625 is movably inserted in the sleeve 1621. The core rod 1625, when moving upwards and downwards, drives the first rod 1623 and the second rod 1624 to move, and accordingly makes the V-shaped flexible element 1622 deformed so to change the angle A1 of the reflector 161.

Referring to FIG. 5, a decomposition diagram of the reflection angle adjustment mechanism of FIG. 1 is shown. The stopper 1626 is fixed on the inner wall of the sleeve 1621 and defines the first stopping position P1 and the second stopping position P2.

The pushing member 1627 is movably disposed in the sleeve 1621. One end selectively presses the first stopping position P1 or the second stopping position P2 of the stopper 1626, and the other end separately presses the core rod 1625. To put it in greater details, the pushing member 1627 comprises at least one stopping portion 1627a. The operating rod 1629 may push the pushing member 1627, so that the stopping portion 1627a of the pushing member 1627 is stopped by the bottom surface 1626a of the stopper 1626. Meanwhile, the pushing member 1627 is positioned at the first stopping position P1 of the stopper 1626. When the operating rod 1629 again pushes the pushing member 1627 and makes the pushing member 1627 rotated, the stopping portion 1627a slides in the sliding groove 1626b of the stopper 1626 until the stopping portion 1627a is stopped by the top wall 1626c of the sliding groove 1626b. Meanwhile, the pushing member 1627 is positioned at the second stopping position P2 of the stopper 1626.

The elastic member 1628 is mounted on the core rod 1625. The elastic member 1628 and the core rod 1625 may together be disposed in the sleeve 1621. One end 1628a of the elastic member 1628 presses the stopping point 1625a of the core rod 1625 and is restricted by the stopping point 1625a. The other end 1628b presses the inner wall of the tapered end portion 1621a of the sleeve 1621 (when the elastic member 1628 is disposed in the sleeve 1621). In the course of pushing the pushing member 1627 to be selectively stopped at the first stopping position P1 or the second stopping position P2 by the operating rod 1629, the pushing member 1627 drives the core rod 1625 to move, so that the elastic member 1628 is deformed (one end 1628a of the elastic member 1628 is deformed downwards in comparison to the other end 1628b) and generates elastic potential energy variation (stores or releases elastic potential energy variation). Through the first rod 1623 and the second rod 1624 pivotally connected to the core rod 1625, the pushing member 1627 further drives the V-shaped flexible element 1622 to slide with respect to the cover 145 (FIG. 4) and drive the reflector to change its angle A1 (FIG. 4).

In another embodiment, the reflection angle adjustment mechanism 162 may dispense the sleeve 1621. Under such design, the core rod 1625 is movably disposed in the through hole 1451 (FIG. 4) of the cover 145 (FIG. 4). The core rod 1625 transitionally or slightly interferes with the through hole 1451 of the cover 145 to avoid the core rod 1625 automatically changing the angle A1. However, the transitional or slight interference does not affect the movability of the core rod 1625 with respect to the through hole 1451 of the cover 145.

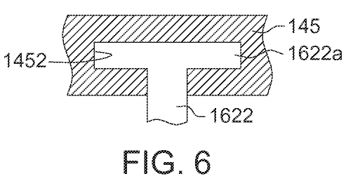

Referring to FIG. 6, a cross-sectional view along a direction 6-6′ of FIG. 4 is shown. The cover 145 has two T-shaped sliding grooves 1452. Each of the two ends of V-shaped flexible element 1622 comprises two T-shaped sliding portions 1622a slidably disposed in a corresponding T-shaped sliding groove 1452. Due to the design of T-shaped structure, the V-shaped flexible element 1622 does not come off the T-shaped sliding groove 1452 easily.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting device with adjustable color temperature, comprising:
a reflection cap having a recess;
a substrate disposed on a bottom of a recess;
a light source disposed on the substrate for emitting light;
a first wavelength transformation layer disposed on the substrate and surrounding the light source;
a second wavelength transformation layer disposed on the substrate and surrounding the first wavelength transformation layer;
a cover disposed over the light source and fixed on the reflection cap;
an angle adjustable reflection device facing toward the light source and disposed on the cover, wherein the angle adjustable reflection device comprises:
a reflection angle adjustment mechanism movably disposed on the cover; and
a reflector disposed on the reflection angle adjustment mechanism;
wherein, a ratio of the light reflected by the reflector to be incident on the first wavelength transformation layer to that being incident on the second wavelength transformation layer is adjusted through the angle adjustment of the reflector by the reflection angle adjustment mechanism to generate light with different color temperature.

2. The light emitting device according to claim 1, wherein the first wavelength transformation layer is a red phosphor layer and the second wavelength transformation layer is a green phosphor layer.

3. The light emitting device according to claim 1, wherein the reflection angle adjustment mechanism comprises:
a core rod movably inserted in a through hole of the cover; and
a first rod and a second rod intersecting each other and pivotally connected to the core rod respectively;
a V-shaped flexible element having an inner surface and an outer surface, wherein the outer surface faces toward the light source, and the inner surface is pivotally connected to the first rod and the second rod respectively, and the reflector is pasted on the outer surface.

4. The light emitting device according to claim 3, wherein the cover further has two sliding grooves, and each of the two ends of the V-shaped flexible element comprises two sliding portions each being movably disposed in the corresponding sliding groove.

5. The light emitting device according to claim 4, wherein the reflection angle adjustment mechanism further comprises:
a sleeve fixed on the through hole of the cover for encapsulating the core rod;
a stopper fixed on the inner wall of the sleeve, wherein the stopper has a first stopping position and a second stopping position;
a pushing member movably disposed in the sleeve, wherein one end of the pushing member selectively presses the first stopping position or the second stopping position of the stopper, and another end of the pushing member is connected to the core rod;
an elastic member mounted on the core rod; and
an operating rod for pushing the pushing member;
wherein, during the operating rod pushing the pushing member to be stopped at the first or the second stopping position, the pushing member drives the core rod to move, so that the elastic member is deformed to generate elastic potential energy variation, and the pushing member, through the first and the second rod pivotally connected to the core rod, further drives the sliding portions of the V-shaped flexible element to slide in the sliding grooves and drive the reflector to change the angle of the reflector.

6. The light emitting device according to claim 5, wherein the light source is an LED.

7. The light emitting device according to claim 6, wherein the light source is a blue LED chip.

8. The light emitting device according to claim 7, further comprising a transparent encapsulating layer encapsulating the blue LED chip.
